(19) United States
(12) Patent Application Publication
(10) Pub. No.: US 2025/0155298 A1
(43) Pub. Date: May 15, 2025

(54) TEMPERATURE SENSOR CONNECTOR

(71) Applicant: Airbus Operations Limited, FILTON (GB)

(72) Inventor: Renil FOSTER, FILTON (GB)

(21) Appl. No.: 18/943,092

(22) Filed: Nov. 11, 2024

(30) Foreign Application Priority Data
Nov. 15, 2023 (GB) 2317535.9

(51) Int. Cl. G01K 13/02; B64D 37/30; B64D 37/32; G01K 1/14

(52) U.S. Cl. CPC G01K 13/02; B64D 37/30; B64D 37/32; G01K 1/14

(57) ABSTRACT

A connector configured to attach to a boss, the connector including: a connector body having an attachment arrangement configured to attach the connector body to the boss; and a temperature sensing element inserted through a through-hole of the connector body. A first end of the temperature sensing element is configured to attach to a data line and a second end of the temperature sensing element configured to be inserted into an orifice of the boss to sense a temperature of the boss. The temperature sensing element is configured to move relative to the connector body.

### CROSS-REFERENCES TO RELATED APPLICATIONS

This application claims the benefit of Great Britian Patent Application Number 2317535.9 filed on Nov. 15, 2023, the entire disclosures of which are incorporated herein by way of reference.

### FIELD OF THE INVENTION

The present invention relates to a connector for attaching to a boss, an assembly comprising the connector and the boss, and an aircraft.

### BACKGROUND OF THE INVENTION

The implementation of hydrogen fuels as a viable means to power aircraft presents numerous challenges. The low ignition energy and wide flammability range of hydrogen fuels underlines the importance of preventing and mitigating leaks from the fuel system. Yet the very low temperature of hydrogen fuels, which are cryogenic in the case of liquid hydrogen, as well as the pressurized fuel system these fuels are contained within, present difficulties in maintaining such a closed system. Ongoing monitoring within and surrounding the fuel system can therefore be necessary.

The fuel system may include one or more temperature sensors arranged to monitor for leaks and other events requiring investigation based upon a detected temperature change. The design of these temperature sensors may require particular consideration given the difficult environmental conditions, such as the exposed temperatures and aerodynamic loads that can act on the sensors.

### SUMMARY OF THE INVENTION

A first aspect of the invention provides a connector for attaching to a boss, the connector comprising: a connector body configured to be secured to the boss; and a temperature sensing element inserted through a through-hole of the connector body, a first end of the temperature sensing element configured to attach to a data line and a second end of the temperature sensing element configured for insertion into an orifice of the boss to sense a temperature of the boss; wherein the temperature sensing element is configured to move relative to the connector body.

With this arrangement, stress concentrations at the interface between the connector body and the temperature sensing element can be reduced. For instance, if the temperature sensing element is pulled at the second end (e.g., via the data line) the connector allows some relative movement that can alleviate stresses that might otherwise be generated at a fixed connection.

The connector body may have an attachment means, such as a thread or snap-fit connection, for securing the connector body to the boss.

The connector may comprise a flange attached to the temperature sensing element. The connector body may be configured to restrict movement of the flange to limit movement of the temperature sensing element relative to the connector body.

The flange can provide a means of engaging the temperature sensing element so that the movement of the sensing element can be limited or controlled. Movement towards the first end of the connector body can be limited to prevent the sensing element disengaging from the orifice of the boss-preventing an interruption to its functionality. Movement away from the first end of the connector body can be limited to prevent impact with any structure at the bottom of the orifice, such as the boss or structure on which the boss is situated.

The connector body may be configured to retain the flange within a cavity of the connector body to hold the temperature sensing element in the orifice.

The cavity retaining the flange can allow movement of the temperature element to be limited in all directions.

The connector may comprise one or more resilient elements configured to bias the temperature sensing element towards a bottom of the orifice.

The resilient element may be a coiled spring.

The resilient elements can dampen any movement of the temperature sensing element.

The connector body may comprise a first housing portion and a second housing portion coupled together to form the cavity.

This can provide for easier assembly of the connector body.

The one or more resilient elements may be positioned in the cavity.

The cavity can provide a suitable location for the resilient elements. The resilient elements can react off any inner surface of the cavity, reducing or eliminating the need to fixedly attach the resilient element to the connector body.

The first housing portion and second housing portion may be releasably coupled together.

This can allow easier assembly and disassembly of the connector body.

The first housing portion may be releasably coupled to the second housing portion via a threaded connection.

The through-hole and/or orifice may be sized to substantially prevent lateral movement of the temperature sensing element.

This can help restrict movement of the temperature sensing element that can improve its contact with the boss and thereby improve the temperature reading.

The temperature sensing element may be a Gallium Arsenide (GaAs) fiber optic temperature sensing element.

A second aspect of the invention provides an assembly comprising the connector of the first aspect and a boss protruding from an outer wall of a fluid container, wherein the temperature sensing element is inserted into an orifice of the boss and configured to sense a temperature of the boss to determine a temperature of a fluid in the fluid container.

The boss may comprise a thermally conductive material surrounding the orifice. The thermally conductive material may form a thermal path (optionally a linear thermal path) between the orifice and the fluid container. The thermally conductive material may form a linear thermal path that extends parallel to a longitudinal axis of the orifice towards the fluid container.

The thermally conductive material may be a metal. The thermally conductive material may be stainless steel, an aluminum alloy, or a nickel iron alloy.

The boss may be welded or otherwise attached to the fluid container, or integrally formed with the fluid container, for example by forging or 3D printing.

A thickness of the boss extending perpendicularly from a wall of the orifice may be substantially constant.

A cylindrical boss can ensure a more uniform temperature profile to the orifice that can give a more reliable temperature reading.

The connector may be releasably coupled to the boss. The connector may be releasably coupled to the boss via a threaded connection.

This can provide easier assembly and disassembly of the connector from the boss. Inspection and repair of the assembly may therefore be easier.

The fluid may be liquid hydrogen fuel or gaseous hydrogen fuel.

The fluid container may be a pipe. The fluid container may be a fuel pipe of a fuel system.

The pipe may be a double-walled pipe.

The double-walled pipe may comprise an inner pipe and an outer pipe surrounding the inner pipe, and the boss may protrude from an outer wall of the outer pipe.

The fluid container may be a fuel tank.

A third aspect of the invention provides an aircraft comprising the assembly of the second aspect.

The assembly may be located in a wing, tail, engine, fuselage or auxiliary/fuel pod of the aircraft.

The allowable relative movement between the connector and the temperature sensing element can be particularly advantageous on an aircraft wing where wing bending, vibrations and other effects could otherwise introduce stress into the interface between the temperature sensing element and the connector.

A fourth aspect of the invention provides an aircraft comprising: a hydrogen fuel container with a boss protruding from an outer wall of the container for releasably attaching to a connector; the boss comprising an orifice for slidably receiving a sensing element of the connector, the orifice having a constant cross-section and a closed end of the orifice formed by a thermally conductive material configured to form a thermal path to an inner wall of the hydrogen fuel container.

The closed end of the orifice may be formed by the orifice or the hydrogen fuel container.

The container may be a double-walled hydrogen fuel pipe comprising an inner pipe and an outer pipe surrounding the inner pipe, and the boss protrudes from an outer wall of the outer pipe.

A thickness of the boss extending perpendicularly from a wall of the orifice may be substantially constant.

### BRIEF DESCRIPTION OF THE DRAWINGS

Embodiments of the invention will now be described with reference to the accompanying drawings, in which:

FIG. 1 shows an aircraft;

FIG. 2 shows an aircraft assembly according to an example of the invention;

FIG. 3 shows a connector attached to a boss of the aircraft assembly;

FIG. 4 shows a cross-section of the aircraft assembly at the section A-A;

FIG. 5 shows a side view of the aircraft assembly indicating the position of the section A-A;

FIG. 6 shows an exploded view of the aircraft assembly;

FIG. 7 shows a top-down view of the aircraft assembly;

FIG. 8 shows an aircraft assembly according to a section example.

### DETAILED DESCRIPTION OF THE PREFERRED EMBODIMENT(S)

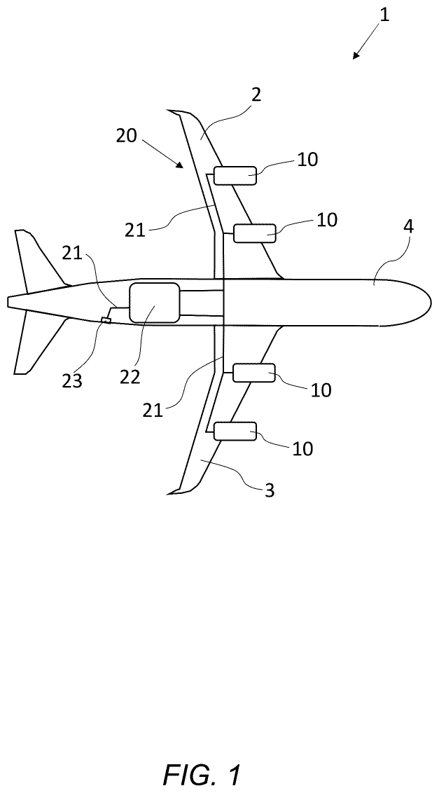

FIG. 1 shows an aircraft 1 with port and starboard fixed wings 2, 3, a fuselage 4, and a fuel system 20 extending through the fuselage 4 and each wing 2, 3. The aircraft 1 is a typical jet passenger transonic transport aircraft although the invention is applicable to a wide variety of aircraft types, including commercial, military, passenger, cargo, jet, propeller, general aviation, etc., with any number of engines attached or integral to the wings or fuselage.

The fuel system 20 includes a set of fuel lines 21 arranged to distribute fuel through the aircraft 1, as required. The fuel lines 21 extend between one or more fuel tanks 22 and refueling ports 23 of the fuel system 20 to deliver fuel to the engines 10 of the aircraft 1.

It will be appreciated that the configuration of the engines 10 and the fuel system 20 is not central to the invention and may be arranged differently to that shown in the figures. The fuel tank(s) 22 may be located in any suitable location on the aircraft 1, such as in separate tanks below the wings 2, 3 (e.g., in fuel pods) or within the wingbox of the wings 2,3. FIG. 1 shows a fuel tank 22 located towards the rear of the fuselage 4.

The fuel system 20 may be a hydrogen fuel system including hydrogen fuel lines 21 and fuel tanks 22. Endeavors to increase aircraft efficiency and environmental sustainability mean that improvements to existing aircraft are continuously being made, with one such solution being the use of gaseous and liquid hydrogen. These fuels are held in a pressurized fuel system at very low temperatures that can require constant monitoring to ensure normal operation of the system.

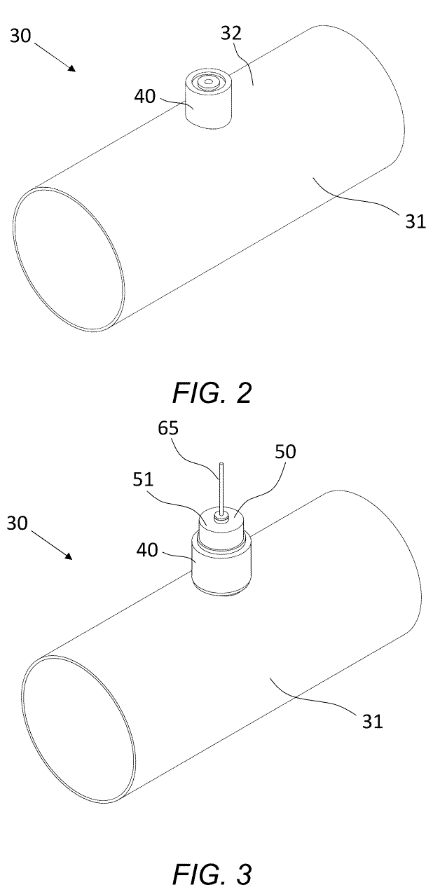

FIG. 2 shows part of an aircraft assembly 30 comprising a fluid container 31. The fluid container 31 in the present example is a fuel pipe 31 configured to convey a fuel, such as liquid or gaseous hydrogen, therethrough. In some examples, the fluid container 31 may be a fuel tank 22 configured to store a fuel, such as those shown in FIG. 1. In other examples, the fluid container 31 may be a pipe or tank configured to convey or store water or other liquid.

A boss 40 is attached to and protrudes from the fluid container 31. In particular, the boss 40 protrudes from an outer wall 32 of the fluid container 31. The boss 40 may be fixedly attached to the fluid container 31. The boss 40 may welded to the fluid container 31. The boss 40 may be separated from the interior of the fluid container 31. Alternatively, the boss 40 may be inserted into a hole in the fluid container 31 so as to directly contact fluid within the fluid container 31.

The fluid container 31, and boss 40 attached to the fluid container 31, may be located in any suitable location on the aircraft, such as in a wing 2,3, tail, engine 10, fuselage 4, or auxiliary pod of the aircraft 1.

FIG. 3 shows a connector 50. The connector 50 includes a connector body 51 attached to the boss 40. The connector body 51 is configured to be secured to the boss 40. In this case, the connector body 51 is releasably coupled to the boss 40 via an attachment means. For instance, the connector body 51 may attach to the boss 40 via a threaded connection. Alternative attachment means will be apparent to the skilled person, such as a snap-fit connection.

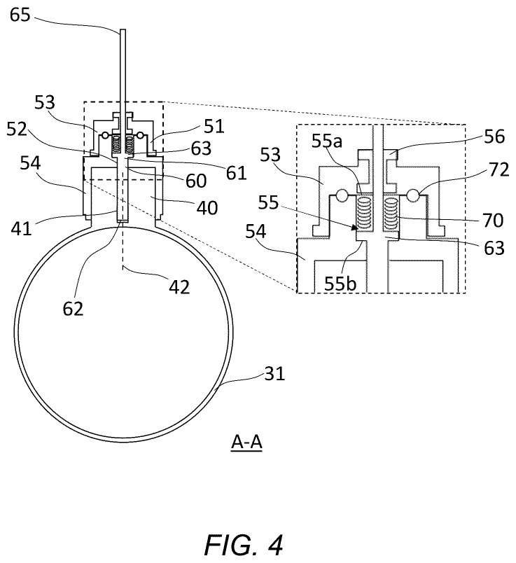

The connector 50 includes a temperature sensing element 60 inserted through a through-hole 52 of the connector body 51 (See FIG. 4). The temperature sensing element 60 is arranged to sense a temperature of the boss 40. The temperature sensing element 60 may be an optical or electric temperature sensing element. In the present example, the temperature sensing element 60 is a Gallium Arsenide fiber optic temperature sensing element. In sensing a temperature of the boss 40, a temperature of the fluid within the fluid container 31 may be inferred, as will be discussed in further detail below.

Aerodynamic loads, temperature fluctuations, and other mechanical stresses can each induce stresses at the interface between the connector body 51 and the temperature sensing element 60 unless these are counteracted. To account for this, the temperature sensing element 60 is configured to move relative to the connector body 51.

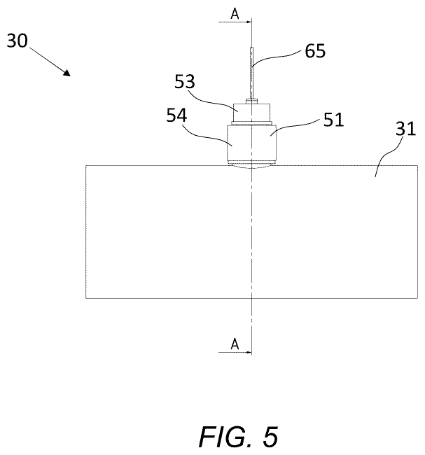

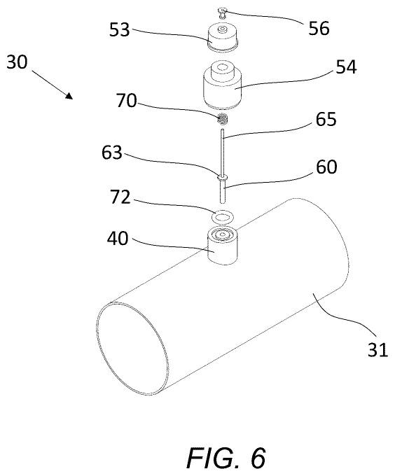

FIG. 4 shows a cross-section of the aircraft assembly 30 at the section A-A indicated in FIG. 5. FIG. 6 shows an exploded view of the aircraft assembly 30.

The connector body 51 comprises a first housing portion 53 and a second housing portion 54 coupled together. The first and second housing portions 53, 54 may be sealed together using an O-ring 72, or similar gasket. The first housing portion 53 is located towards a first end of the connector body 51 furthest from the fluid container 31 with respect to the second housing portion 54. The second housing portion 54 is located towards a second end of the connector body 51 adjacent to the fluid container 31. The connector body 51 may comprise a gasket 56 that seals the end of the through-hole 52 adjacent the first end of the connector body 51 and forms a fluidic seal with a data line 65 extending from the temperature sensing element 60.

The boss 40 includes an orifice 41. The orifice 41 is configured to receive the temperature sensing element 60. The cross-section of the orifice 41 corresponds to the cross-section of the temperature sensing element 60 configured to enter the orifice 41. In this case the cross-section of the orifice 41 is circular. The orifice 41 has a constant cross-section along its length. The temperature sensing element 60 is configured to move in a straight line along the longitudinal axis 42 of the orifice 41. The temperature sensing element 60 is configured to slide within the orifice 41. The orifice 41 may be sized such that lateral movement of the temperature sensing element, i.e., movement perpendicular to the longitudinal axis of the temperature sensing element 60, is substantially prevented. Similarly, the through-hole 52 may be sized to substantially prevent lateral movements. The temperature sensing element 60 is arranged to contact the wall of the orifice 41 such that the temperature sensing element 60 can sense a temperature of the boss 40.

The boss 40 is made from a thermally conductive material. The boss 40 may be formed of any suitably thermally conductive material. The thermally conductive material may be a metal. Metal in the aerospace context is suited for mechanical strength and deformation properties, particularly at low temperatures. The metal may be a stainless steel, such as SAE 316L; an aluminum alloy, such as aluminum 2024; a nickel iron alloy, such as Invar; or any other suitable material. Such materials are lightweight, weldable and with high thermal conductivity. The boss 40 may be formed of the same material as the fluid container 31. Alternatively, the boss 40 may be formed of a different material having the same or a greater thermal conductivity than the material of the fluid container 31.

The thermally conductive material of the boss 40 extends directly from the fluid container 31 to the orifice 41 to form a linear thermal path (that is, a straight thermal path) between the orifice 41 and the fluid container 31. In the present example, the linear thermal path extends parallel to the longitudinal axis 42 of the orifice 41. The linear thermal path preferably defines the shortest distance between the fluid container 31 and each respective portion of the orifice 41 to minimize thermal losses therebetween. This can improve the reliability of the temperature reading in the event of varying temperature conditions external to the boss 40.

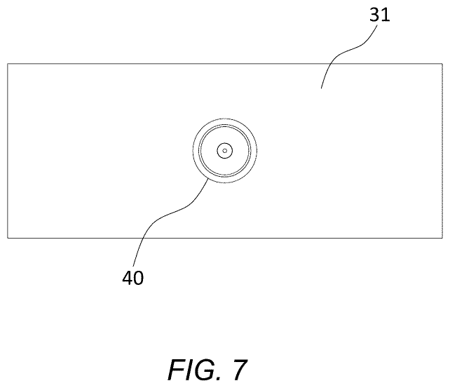

The shape of the boss 40 may be arranged such that the thickness of the boss 40 extending perpendicularly from the outer wall of the orifice 41 is substantially constant. In the present example, the boss 40 has a substantially cylindrical outer profile extending from the fluid container 31, see for instance FIGS. 6 and 7. This can ensure an even temperature profile through the thickness of the boss 40 between the outer wall of the boss 40 and the temperature sensing element 60.

The temperature sensing element 60 has a first end 61 and a second end 62. The first end 61 is configured to attach to a data line 65. The data line 65 may be configured to carry a signal from the temperature sensing element 60 to a monitoring system (not shown).

A flange 63 may be attached to the temperature sensing element 60. The flange 63 may be positioned between the temperature sensing element 60 and the data line 65 such that the first end 61 of the temperature sensing element 60 is indirectly attached to the data line 65 via the flange 63, such as shown in FIG. 6.

The flange 63 is configured to contact the inner walls of the connector body 51. The inner walls of the connector body 51 form the outer boundary of a cavity 55 within the connector body 51. In this manner, the flange 63 is contained within the cavity 55. The size of the cavity in a direction parallel to the longitudinal axis of the temperature sensing element 60 determines the moveability of the temperature sensing element 60. In other words, the flange 63 is contained between the upper wall 55a and lower wall 55b of the cavity 55 to prevent the temperature sensing element 60 from dislodging from the through-hole 52 of the connector body 51, and thereby from dislodging from the orifice 41 of the boss 40 when the connector 50 is attached to the boss 40. The upper and lower walls 55b are spaced along the longitudinal axis of the through-hole 52. The spacing between the upper and lower walls 55a, 55b determines the permitted movement of the temperature sensing element 60 in a direction parallel to the longitudinal axis of the through-hole 52.

The first housing portion 53 may comprise the upper wall 55a of the cavity 55, while the second housing portion 54 may comprise the lower wall 55b of the cavity 55, such that the cavity 55 is formed between the first and second housing portions 53, 54. The first and second housing portions 53, 54 may be releasably coupled together, for example via a threaded connection, to facilitate easier insertion and removal of the flange 63 into the cavity 55. Alternatively, the first and second housing portions may be bonded together by adhesive.

Direct contact of the temperature sensing element 60 with the fluid container 31 may not be required in order to provide an accurate temperature reading of the boss 40. As shown in FIG. 5, a space may be defined between the fluid container 31 and the temperature sensing element 60 (e.g., an air gap) such that the temperature sensing element 60 is unable to directly contact the fluid container 31. In other words, a length of the temperature sensing element 60 may be less than the depth of the orifice 41. This can protect the temperature sensing element 60 from impact against the fluid container 31, e.g., due to aerodynamic disturbances of the aircraft 1. Alternatively, in other examples, the temperature sensing element 60 may be able to contact the fluid container 31.

In the present example, the outer wall 32 of the fluid container 31 forms the closed end of the orifice 41. In some examples, an end portion of the boss 40 may form the closed end of the orifice 41. In such cases, the space (e.g., air gap) may be defined between the closed end of the orifice 41 and the temperature sensing element 60.

The connector 50 may comprise one or more resilient elements 70, such as a coiled spring, configured to bias the temperature sensing element 60 towards the bottom of the orifice 41. In particular, the resilient element(s) 70 may press against the flange 63 to push the temperature sensing element 60 into the orifice 41. The resilient elements 70 are housed in the cavity so as to be sandwiched between the first housing portion 53 and second housing portion 54. By positioning the resilient elements 70 in the cavity, the resilient elements 70 can react against the inner surfaces of the cavity when biasing the temperature sensing element 60. This can allow the spring to be installed in the absence of fixing the resilient element 70 to a surface of the connector body 51, for example by adhesive. The resilient element 70 can be more easily inserted and removed from the cavity.

In the previous examples the invention has been discussed in the context of a single-walled pipe 31, whereas hydrogen fuels are typically conveyed along double-walled pipes due to the very low temperatures of hydrogen fuel and the need to form an insulation barrier between the fuel and outer atmosphere.

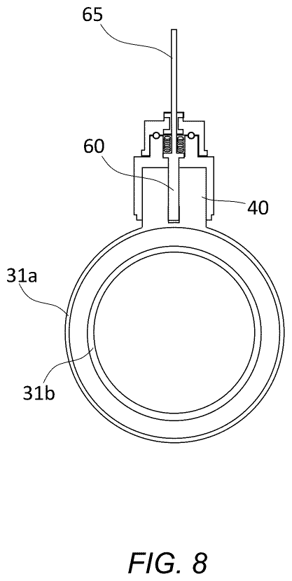

FIG. 8 shows an example of a boss 40 protruding from an outer wall of a double-walled pipe, and, in particular, the outer pipe 31a of the double-walled pipe. The inner pipe 31b can be arranged to convey the hydrogen fuel throughout the fuel system 20, while the space between the inner and outer pipes 31a, 31b may be used as a containment space to contain any hydrogen fuel leaked from the inner pipe 31b.

Positioning the boss 40 on the outer wall of the outer pipe 31a can allow the temperature sensing element 60 to be used to determine a temperature of the outer pipe 31a, which can be used to infer temperature changes in the space between the inner and outer pipes 31a, 31b. A change in temperature of the space may be indicative of a leak from the inner pipe 31b.

In alternative examples, the boss 40 may protrude from the inner pipe 31b of a double-walled pipe to determine a temperature of the fluid in the inner pipe 31b. In this case, an aperture may be formed in the outer pipe 31a to allow the temperature sensor to extend to the data line 65 external to the outer pipe 31a.

It will be appreciated that while the invention has been described in the context of hydrogen fuels, the assembly 30 may be similarly applied for measuring the temperature of other fuels, such as kerosene and other conventional aviation fuels, or fluids such as water.

Where the word ‘or’ appears, this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A connector for attaching to a boss, the connector comprising:
a connector body configured to be secured to the boss; and
a temperature sensing element inserted through a through-hole of the connector body, a first end of the temperature sensing element configured to attach to a data line and a second end of the temperature sensing element configured for insertion into an orifice of the boss to sense a temperature of the boss;
wherein the temperature sensing element is configured to move relative to the connector body.

2. The connector of claim 1, comprising a flange attached to the temperature sensing element, the connector body configured to restrict movement of the flange to limit movement of the temperature sensing element relative to the connector body.

3. The connector of claim 2, wherein the connector body is configured to retain the flange within a cavity of the connector body to hold the temperature sensing element in the orifice.

4. The connector of claim 3, wherein the connector body comprises a first housing portion and a second housing portion releasably coupled together to form the cavity.

5. The connector of claim 1, comprising one or more resilient elements configured to bias the temperature sensing element towards a bottom of the orifice.

6. The connector of claim 5,
wherein the connector body is configured to retain the flange within a cavity of the connector body to hold the temperature sensing element in the orifice, and
wherein the one or more resilient elements are positioned in the cavity.

7. The connector of claim 1, wherein at least one of the through-hole or the orifice is sized to substantially prevent lateral movement of the temperature sensing element.

8. An assembly comprising the connector of claim 1 and the boss protruding from an outer wall of a fluid container, wherein the temperature sensing element is inserted into the orifice of the boss and configured to sense the temperature of the boss to determine a temperature of a fluid in the fluid container.

9. The assembly of claim 8, wherein the boss comprises a thermally conductive material surrounding the orifice, wherein the thermally conductive material forms a thermal path between the orifice and the fluid container.

10. The assembly of claim 9, wherein the thermally conductive material is a metal.

11. The assembly of claim 8, wherein a thickness of the boss extending perpendicularly from a wall of the orifice is substantially constant.

12. The assembly of claim 8, wherein the connector is releasably coupled to the boss.

13. The assembly of claim 8, wherein the fluid is liquid hydrogen fuel or gaseous hydrogen fuel.

14. The assembly of claim 13, wherein the fluid container is a double-walled pipe which comprises an inner pipe and an outer pipe surrounding the inner pipe, and the boss protrudes from the outer wall of the outer pipe.

15. The assembly of claim 8, wherein the fluid container is a fuel tank.

16. An aircraft comprising the assembly of claim 8.

17. The aircraft of claim 16, wherein the assembly is located on a wing of the aircraft.

18. An aircraft comprising:
a hydrogen fuel container with a boss protruding from an outer wall of the container for releasably attaching to a connector;
the boss comprising an orifice for slidably receiving a sensing element of the connector, and
the orifice having a constant cross-section and a closed end of the orifice formed by a thermally conductive material configured to form a thermal path to an inner wall of the hydrogen fuel container.

19. The aircraft of claim 18, wherein the container is a double-walled hydrogen fuel pipe comprising an inner pipe and an outer pipe surrounding the inner pipe, and the boss protrudes from the outer wall of the outer pipe.

20. The aircraft of claim 18, wherein a thickness of the boss extending perpendicularly from a wall of the orifice is substantially constant.
